(19) United States
(12) Patent Application Publication
(10) Pub. No.: US 2007/0228654 A1
(43) Pub. Date: Oct. 4, 2007

(54) Card game

(75) Inventor: Charles P. Tabler, Cincinnati, OH (US)

Correspondence Address: FROST BROWN TODD, LLC, 2200 PNC CENTER, 201 E. FIFTH STREET, CINCINNATI, OH, 45202, US

(73) Assignee: Charles P. Tabler LLC

(21) Appl. No.: 11/397,237

(22) Filed: Apr. 4, 2006

(51) Int. Cl. A63F 1/00; G06F 19/00

(52) U.S. Cl. 273/292; 463/27

(57) ABSTRACT

The present invention provides a method of playing a card game comprising the steps of providing a dealer, providing at least one player, providing a playing surface that displays a plurality of cards having graphical elements, the at least one player selecting at least one player card on said playing surface, the dealer identifying at least one dealer card having graphical elements, and determining whether the graphical elements on said player card match the graphical elements on said dealer card.

### BACKGROUND OF THE INVENTION

The present invention generally relates to a card game. More particularly, it relates to a method of playing a card game wherein players attempt to match cards identified by a dealer. While the present invention generally relates to gambling or wagering games, and more specifically to a card game to be played at casinos, it can easily be adapted for leisure playing in the form of a board or computer game.

Casino and game aficionados are constantly in search of games that are simple and that incorporate a simple and straightforward set of rules. There are a variety of games and pastimes that have been developed for entertainment and relaxation. Many such games involve card games where wagers are placed upon the outcome.

Casinos and other gaming establishments provide a number of popular games such as Roulette, Caribbean Stud, Texas Hold 'em, Seven Card Stud, and slot machines. While slot machines and other electronic games are popular, players and gaming establishments are always looking for new table games because of the challenge, excitement, and higher stakes they offer.

### BRIEF SUMMARY OF THE INVENTION

The present invention provides a method of playing a card game comprising the steps of providing a dealer, providing at least one player, providing a first plurality of player cards having graphical elements, the at least one player selecting at least one player card from among said first plurality of cards, providing a second plurality of cards having graphical elements, the dealer identifying at least one dealer card from among the second plurality of cards, and determining whether the graphical elements on said player card match the graphical elements on said dealer card.

### BRIEF DESCRIPTION OF THE DRAWING

FIG. 1 is a plan view of a playing surface.

FIG. 2 is a schematic of an embodiment of the present invention.

### DETAILED DESCRIPTION OF THE INVENTION

The present invention comprises a relatively simple and fast paced game that is well suited for play as a wagering game in casinos, on a computer, or at home. It can also be played without betting. This game of the present invention can be played by a single person or multiple persons at the same time.

Generally, the at least one player attempts to select cards that match cards identified by a dealer. The dealer can be a person who identifies or draws cards from a deck of cards. The dealer can also be a computer.

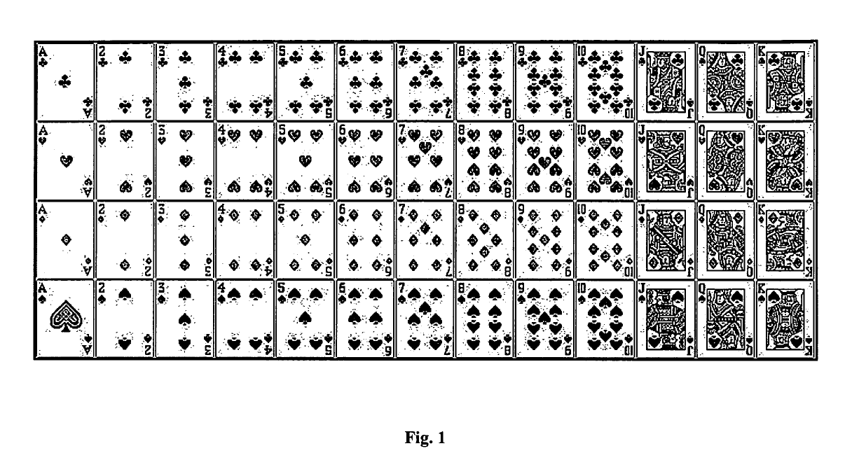

The cards used in the present invention can be a standard 52 card playing deck. They can also be any cards that contain graphical elements; typically different graphical elements are depicted on at least some of the cards, so that the cards are able to be distinguished one from another. The cards can be individual cards that are handled by the player(s) and/or the dealer, or they may be pictures of cards depicted on a sheet, such as plastic, cardboard or paper, or computer screen. See FIG. 1.

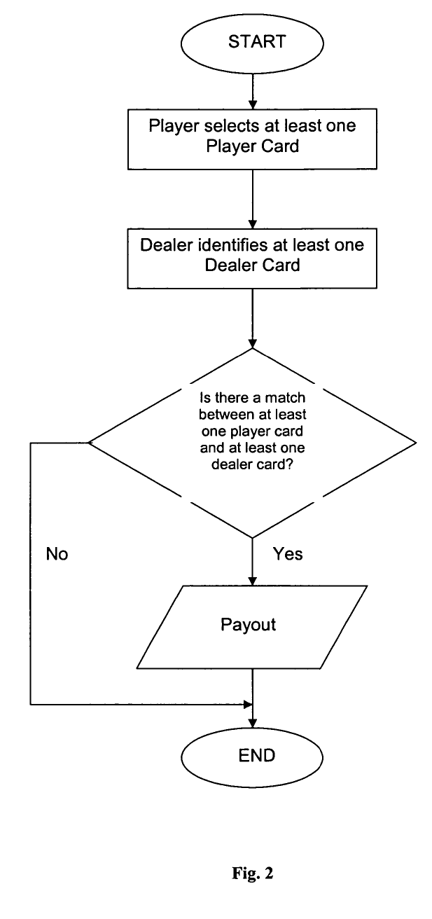

As depicted in FIG. 2, the player(s) selects one or more cards, referred to as player card(s). This selection can occur, for example, by the player's choosing a particular card or cards and signifying that choice by marking the particular card in some way, such as by placing a token over it or selecting it on a computer screen.

The card game of the present invention may be played as an electronic, or computer video game or as a traditional board game.

The dealer can be any person, or machine that administers the game. The dealer identifies one or more cards, referred to as dealer card(s). This identification can occur by the dealer's drawing cards from a deck of cards. It may also occur by a computer or other machine selecting cards.

It is then determined whether at least one player card matches at least one dealer card by comparing the graphical elements on the player card(s) with that of the dealer card(s). This matching can occur with a visual comparison by the player and/or the dealer of the player card(s) with the dealer card(s). It can also occur by a computer comparison of the player card(s) and the dealer card(s).

The at least one player may wager on whether he will match a player card and a dealer card. The pay-off may be increased if there is more than one match of a player card and a dealer card.

The game of the present invention may also be played with a progressive jackpot controlled by the dealer or house, which is usually initiated with a predetermined contribution by the house. All tables in the same casino or across a group of casinos are preferably electronically connected. For each hand, jackpot wagers may be made by a player putting a predetermined number of chips into the jackpot, for example through a slot in the table or the machine. Any winnings from the jackpot are paid off according to predetermined payoff odds and are in addition to what is paid off by the dealer.

In one embodiment of the present invention, the game is played on a playing surface that has the images of all 52 cards of a standard deck of playing cards, which is the first plurality of cards. See FIG. 1. The one or more player(s) buy into the by purchasing a quantity of colored tokens. Each player purchases a different color token. It will be understood by persons of the skill in the art that other methods of distinguishing the individual player's token can be used, such as different shaped tokens, etc. The player(s) each use five of his tokens per game and select five of the 52 card images on the playing surface and place a token on each of the selected images (i.e., player cards). Multiple players can cover the same player card, i.e., two or more players can cover the 10 of diamonds. After all the players have made their choice of five player cards out of the 52 and placed one of their tokens on each player card, the game begins.

The dealer may shuffle a standard deck of playing cards, which can include cutting the deck. This deck of cards is the second plurality of cards. He then selects a dealer card from the deck of cards. He then places that dealer card on the playing surface over the card image that matches the dealer card. The dealer repeats this step four additional times such that the dealer has identified five dealer cards and covered five playing surface card images. Any player tokens that are placed on player cards on the playing surface that are not covered by a dealer card are removed for the house.

A player wins if he has placed a token on a player card on the playing surface that matches one or more of the five dealer cards. Payoffs are made based on the number of player cards, identified by a particular player's token or chip, that match corresponding dealer cards. An example of such payoffs is as follows:

| Number of Matches | Payoff |
|---|---|
| 1 Match | 10 to 1 (total 10) |
| 2 Matches | 100 to 1 (total 110) |
| 3 Matches | 1,000 to 1 (total 1,110) |
| 4 Matches | 10,000 to 1 (total 11,110) |
| 5 Matches | 50,000 to 1 (total 61,110) |

After all the payoffs are made, the dealer assembles all dealer cards back into the deck and a new round of betting begins.

In another embodiment of the present invention, each of the from one to seven players selects five color coded tokens and places them one at a time on a player card of choice on the playing surface. When all players have placed their tokens on the player cards on the playing surface, the dealer deals each player a five dealer card hand from the deck of playing cards, face down. After all hands are dealt, each of the players in a predetermined order reveals their hand, looking for matches between the dealer cards in their hand and the player cards on the playing surface where they placed their tokens. The process repeats for the rest of the players. The dealer collects all tokens which are not a match as each player reveals his hand of dealer cards. A player wins if he has placed a token on a player card on the playing surface that matches one or more of the five dealer cards. Payoffs are made based on the number of player cards, identified by a particular player's token, that match corresponding dealer cards. After all the payoffs are made, the dealer assembles all dealer cards back into the deck and a new round of betting begins.

In yet another embodiment of the present invention, the game is a video game which is preprogrammed and funded, for example, by a gaming establishment or someone on its behalf. The player selects a machine which satisfies the preferred value for each bet, e.g., 25 cents, 50 cents, $1, $5, etc. The display of the machine exhibits a card image, such as each of the 52 cards in a standard playing deck. The images make up the first plurality of cards. Each player bets, for example, five tokens per game and designates each of the five tokens to be related one at a time to the player card image of their choice, designating five different player cards each with one token. The player can enter five equivalent value tokens into the machine for each game or he can bet from a reserve of tokens in the machine established either by previous winnings or by prepayment. The player then presses the “deal” button and the machine deals and displays a random five dealer card hand from a second plurality of cards. The machine then identifies matches between the dealer cards and images on the selected player cards where the player placed his or her tokens. Matches are paid off according to a set of predetermined payout odds.

Another embodiment of the game of the present invention is designed to be played at home rather than at a gaming establishment. In this embodiment, the cards are dealt and funded by a player designated as the “house.” The house dealer can be a volunteer or he can be chosen by cutting the deck for high or low card among the players. It is designed to be played by, preferably, two to eight players, one of whom is the house dealer and the rest are “action” players. The dealer is responsible for dealing and administering the game and may realize the profits or losses of the game. If a jackpot is to be a part of the game, the dealer must also keep a record of the matches of dealer cards and player cards per player during the jackpot period. The playing surface of the game may display a picture of each of the 52 cards in the standard playing deck, like that of FIG. 1, or some other graphical elements. This playing surface represents the first plurality of cards. Each action player, in a predetermined order buys into the game by receiving or purchasing a certain quantity of tokens, which have common values but individual colors for each player. Each action player selects five of his tokens and places each of them on a player card of choice on the playing surface. More than one action player may choose to place a chip on a particular card image.

When all action players have placed their bets, the dealer deals each action player five dealer cards, face down, from a deck of cards that is the second plurality of cards. After all hands are dealt, the players in a predetermined order reveal the dealer cards in their hand, looking for matches between the dealer cards in their hand and the player card images where they placed their colored token. Matches are paid off by the dealer in accordance with a set of predetermined payoff odds.

In an alternative embodiment of this game, the dealer turns over five dealer cards. After the five dealer cards are turned over, the players look for matches among any of the five dealer cards and the player card images where they placed their colored token. Matches are paid off by the dealer in accordance with a set of predetermined payoff odds.

The dealer collects all tokens which are not a match. After all the payoffs are made, the dealer assembles all playing cards back into the deck and a new round of betting begins. The game ends when all action players agree to stop playing. Tokens are redeemed and profits or losses are determined.

Each of the above embodiments can also be played with a progressive jackpot which is controlled by the house. Such jackpots are well-known in the art. A jackpot is usually initiated by a monetary contribution by the gaming establishment. All tables or machines which are playing the game of the present invention are connected, often electronically, based on certain criteria such as common values of tokens. Such tables or machines can be connected in one area of the casino, the entire casino or across several casinos. All jackpot wagers are continuously totaled and displayed after a predetermined percentage is automatically deducted for the gaming establishment to cover expenses. A player may elect to wager on the jackpot portion of each hand by placing an additional token or chip into a receptacle for such jackpot wagers. This step can be repeated for each hand that the player wishes to make eligible for the jackpot. Any winnings from the jackpot are in addition to what is paid off by the house dealer or machine at the table or location where the player is playing. An example of such a jackpot payoff is as follows:

| Number of Matches | Payoff |
|---|---|
| 3 Matches | ¼ of the current jackpot |
| 4 Matches | ½ of the current jackpot |
| 5 Matches | The entire current jackpot |

In the home variation of the game, the action players must also declare they will participate in a jackpot and agree to continue for a predetermined period of time, for example one hour segments. At the end of the designated period, the entire jackpot is given to the action player who had the most matches during the designated period, unless there is a tie, in which case the jackpot is split. In another variation, the game can be played where the jackpot winner becomes the house dealer and the house dealer becomes an action player at the end of each designated period.

What is claimed is:

1. A method of playing a card game comprising the steps of:
a. providing a dealer,
b. providing at least one player,
c. providing a first plurality of cards having graphical elements,
d. the at least one player selecting at least one player card from among said first plurality of cards,
e. providing a second plurality of cards having graphical elements;
f. the dealer identifying at least one dealer card from among the second plurality of cards,
g. determining whether the graphical elements on said player card match the graphical elements on said dealer card.

2. The method according to claim 1, wherein the dealer is selected from the group consisting of a person, a machine, or a computer.

3. The method according to claim 1, wherein the second plurality of cards is a standard 52 card playing deck.

4. The method according to claim 1, wherein the first plurality of cards is displayed on a computer screen.

5. The method according to claim 1, wherein the first plurality of cards is displayed on a playing surface.

6. The method according to claim 5, wherein the at least one player selects the at least one player card by placing a token on said at least one player card.

7. The method according to claim 6, wherein the token is colored so as to distinguish it from any other player's token.

8. The method according to claim 5, wherein the playing surface consists of images of a standard 52 card playing deck.

9. The method of claim 8 wherein the player selects the at least one player card on said playing surface by placing a token on at least one player card.

10. The method of claim 9 wherein the second plurality of cards is a deck of cards and the dealer identifies at least one dealer card by drawing said dealer card from said deck of cards and placing it on the playing surface over the image that matches the dealer card.

11. The method of claim 10 further comprising the step of the dealer collecting any token not covered by a dealer card.

12. The method according to claim 9, wherein the dealer identifies at least one dealer card by dealing from said deck of cards said at least one dealer card to a player.

13. The method according to claim 9, wherein the dealer identifies at least one dealer card by turning over the top card on said deck of cards.

14. The method according to claim 13, wherein the dealer identifies four more dealer cards by turning over the next four cards on said deck of cards.

15. The method according to claim 12, wherein determining whether the graphical elements on said at least one player card matches the graphical elements on said at least one dealer card is performed by the at least one player looking for matches between the at least one dealer card in his hand and the at least one player card on the playing surface.

16. The method according to claim 13, wherein determining whether the graphical elements on said at least one player card matches the graphical elements on said at least one dealer card is performed by the at least one player looking for matches between the at least one dealer card in his hand and the at least one player card on the playing surface.

17. The method according to claim 1, wherein the method is accomplished with a machine and the player can enter at least one token into the machine for each game or the player can bet from a reserve of tokens in the machine.

18. The method according to claim 17, wherein the machine deals the dealer cards.

19. The method according to claim 1, wherein the game can be played with a progressive jackpot.

20. The method according to claim 19, wherein said jackpot may be initiated by a predetermined contribution.

21. The method according to claim 19, wherein said jackpot is continued for a predetermined period of time or until the total jackpot is won.

22. The method according to claim 15, wherein said jackpot is paid to the player with the highest number of matches and split equally in case of a tie.
